(19) United States
(12) Patent Application Publication
(10) Pub. No.: US 2014/0376116 A1
(43) Pub. Date: Dec. 25, 2014

(54) OPTICAL LENS ASSEMBLY

(71) Applicant: GLOBAL MICROPTICS CO., LTD., TAICHUNG (TW)

(72) Inventors: CHING-SHAN YANG, TAINAN (TW); WU-LI WANG, TAINAN (TW)

(73) Assignee: GLOBAL MICROPTICS CO., LTD., TAICHUNG (TW)

(21) Appl. No.: 14/444,246

(22) Filed: Jul. 28, 2014

Related U.S. Application Data
(63) Continuation-in-part of application No. 13/446,187, filed on Apr. 13, 2012, now abandoned.

(51) Int. Cl. G02B 9/04; G02B 13/00

(52) U.S. Cl. CPC G02B 9/04; G02B 13/0015
USPC 359/793

(57) ABSTRACT

An optical lens assembly includes a first lens, an adhesive layer, and a second lens in sequence, wherein the first and the second lenses are rectangular in shape. The adhesive layer is made of an adhesive acrylic composition. to adhere both sides thereof to interior sides of the first lens and the second lens, and the adhesive layer has following conditions: a transmittance greater than 70%; |n3−n1 |<0.5; and |n3−n2 |<0.5; where n1 is a refractive index of the first lens; n2 is a refractive index of the second lens; and n3 is a refractive index of the adhesive layer.

### RELATED APPLICATION

This application is a continuation in part of U.S. patent application: Ser. No. 13/446,187 titled “OPTICAL LENS ASSEMBLY” filed on Apr. 13, 2012 the subject matter thereof is fully incorporated herein by reference.

### BACKGROUND OF THE INVENTION

1. Field of the Invention

The present invention relates generally to an optical device, and more particularly to an optical lens assembly.

2. Description of the Related Art

Recently , more and more image pick-up consumer devices, such as digital cameras and cell phones, are equipped with an image capture device, such as charge coupled device (CCD) or complementary metal oxide semiconductor (CMOS). Increasingly compact and decreasing size of such image pick-up devices requires commensurately more compact and size reduction of image capture devices incorporated therein.

FIG. 1 shows a conventional miniature lens assembly, including a first lens 40 and a second lens 50 attached to the first lens 40. The second lens 50 is stacked on the first lens 40 and attached thereto through their boundaries 41 and 51 so that interior sides 42, 52 thereof are separated with air therebetween.

When light L2 emits through the first and the second lenses 40, 50 other than in the normal direction, as shown in FIG. 2, there will be a light shift because of passing through the second lens 50, air, and the first lens 40 in sequence, and therefore a transmittance of the light L2 is poor. In order to compensate the light shift, it may have to increase the distance between the interior sides 42, 52 of the first and the second lenses 40, 50. However, it will enlarge the size of the lens assembly 2.

In addition, for common optical lens assemblies in the industry such as, e.g., U.S. Pat. No. 6,473,238, titled “Lens Arrays,” the gaps between lenses are filled with fluoropolymers of low refractive index, which increases the thickness of a lens assembly, and hinders the development of miniature tendency. Some prior art, such as published US Patent No. 2010/0232037, titled “Imaging Lens,” discloses features of adhering multiple lenses to form a lens assembly. Thus, such prior art optical lens assemblies conventionally employ bulky lens arrays and comprise materials having refractive indices resulting in a focal length of the disclosed lens assembly that extends beyond the space allotted in modern image pick up devices. Thus, the problem of providing an optical lens assembly having a small and compact configuration conducive to develop miniature optical devices persists.

### SUMMARY OF THE INVENTION

The present invention addresses such and other problems with the prior art by providing a compact optical lens assembly, which has a low light shift, high transmittance, and small size.

According to the objective of the present invention, an optical lens assembly includes a first lens, an adhesive layer, and a second lens in sequence is provided in the present invention. The first and the second lenses are rectangular in shape. The adhesive layer is made of an adhesive acrylic composition to adhere both sides thereof to interior sides of the first lens and the second lens, and the adhesive layer has following characters:
a transmittance greater than 70%;
   |n3−n1|<0.5; and
   |n3−n2|<0.5;
where n1 is a refractive index of the first lens; n2 is a refractive index of the second lens; and n3 is a refractive index of the adhesive layer.

In a preferred embodiment of the present invention, the lens assembly comprises providing a space between the first lens and the second lens, and placing the the adhesive layer in the space. Moreover, preferred embodiments contemplate a sum of radiuses of curvature of the interior sides of the first lens and the second lens is not equal to zero.

In a particularly preferred embodiment, the thickness of the adhesive layer is greater than 1 micrometer. The refractive index of the adhesive layer according to the present invention is greater than 1 and preferably comprises a range between 1.2 and 1.8.

It is further preferred that the optical lens assembly of the present invention comprises an adhesive layer having a strength of adhesion greater than 1 kgf/m². In a particularly preferred embodiment, the adhesive layer has a strength of adhesion greater than 500 kgf/m².

The adhesive layer of the present invention comprises an acrylic composition including an acrylic compound and an epoxy, wherein the acrylic component is greater than the epoxy component thereof. In preferred embodiments, the adhesive lay may exceed 60 percent of the composition and is particularly preferred to exceed 70%.

In an exemplary embodiment of the present invention, the adhesive layer further comprises properties relative to the refractive indices of n3 and n1, wherein:
n3−n1<0.5.

In another embodiment, the adhesive layer further has properties of refractive indices relative to n3 and n2, wherein:
n3−n2<0.5.
   Exemplary values of n1 are Exemplary values of n1 are between 1.52 and 1.55, n2 are between 1.52 and 1.55, and n3 are between 1.61 and 1.68.

In an embodiment, the first lens is cut from a lens array, which includes a plurality of the first lenses integrally arranged in an array.

In an embodiment, the second lens is cut from a lens array, which includes a plurality of the second lenses integrally arranged in an array.

Therefore, the optical lens assembly of the present invention has a low light shift, high transmittance, and small size adaptable to compact and small image pick-up devices.

### BRIEF DESCRIPTION OF THE DRAWINGS

FIG. 1 is a sketch diagram of the conventional lens assembly;

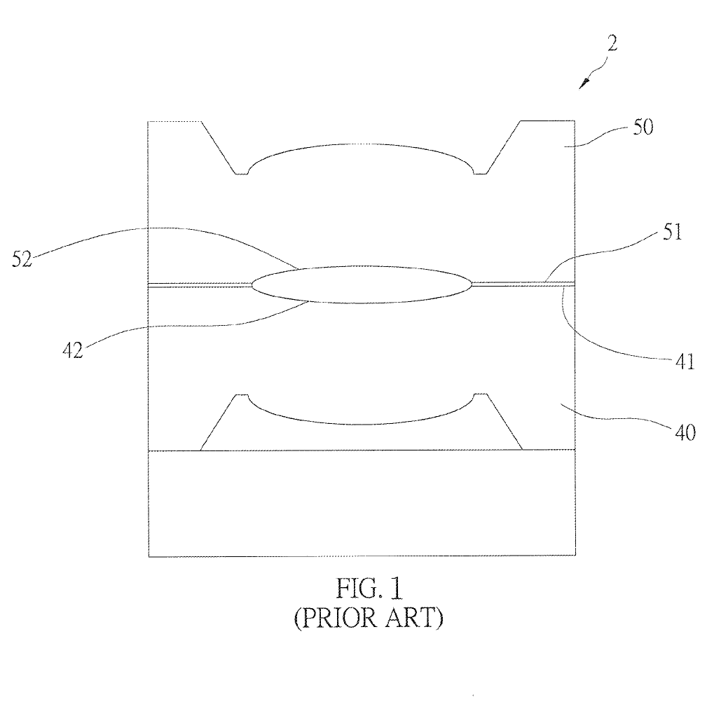

FIG. 2 is a sketch diagram of the conventional lens assembly, showing the light path;

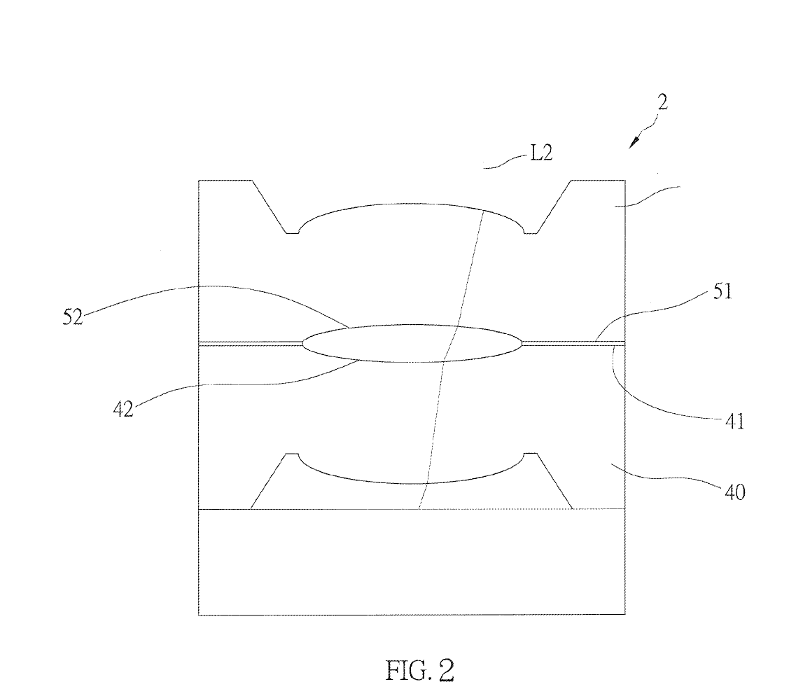

FIG. 3 is a perspective view of a preferred embodiment of the present invention;

FIG. 4 is a sketch diagram of the preferred embodiment of the present invention;

FIG. 5 is a schematic diagram of the preferred embodiment, showing the second lens of rectangular shape is cut from the lens array; and

FIG. 6 is a sketch diagram of the preferred embodiment of the present invention showing the light path.

FIG. 7 is a graphic representation illustrating the focal length of the preferred embodiment of the present invention

### DETAILED DESCRIPTION OF THE INVENTION

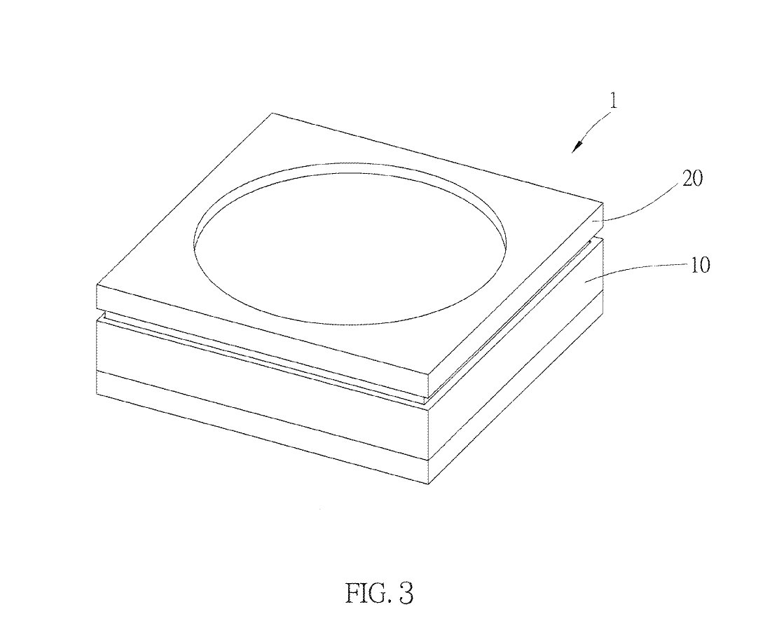

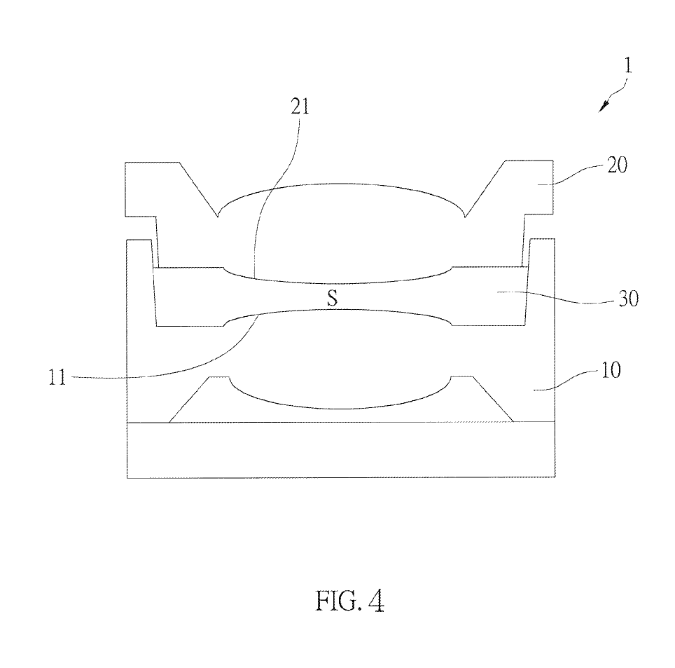

As shown in FIG. 3 and FIG. 4, an optical lens assembly of the preferred embodiment of the present invention includes a first lens 10, an adhesive layer 30, and a second lens 20 in sequence.

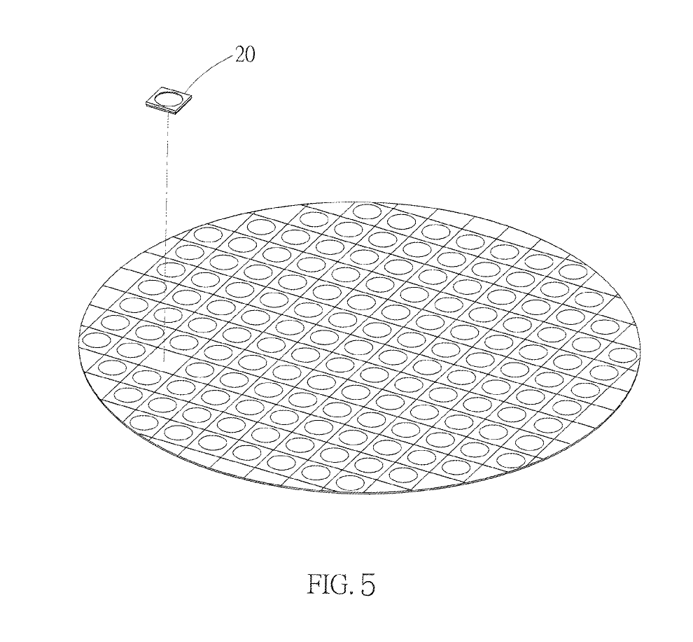

The first lens 10 and the second lens 20 are respectively cut from a lens array. Take the second lens 20 for example, which is shown in FIG. 5, the lens array has a wafer-like structure, and includes a plurality of the first lenses 10 and a plurality of the second lenses 20 which are integrally arranged in an array respectively. As a result, the first lens 10 and the second lens 20 cut from the lens array are both rectangular in shape. Such geometry is convenient for follow-up assembling processes in manufacturing cellphones, laptops, or other devices with optical components. More specifically, the rectangular shape of the first lens 10 and the second lens 20 are helpful for quick locating, which is able to prevent unwanted offsets. The first and the second lenses 10, 20 respectively have an interior side 11, 21, and a space S is formed therebetween. The interior sides 11, 21 respectively have a radius of curvature, and the radius of curvature of the interior side 11 plus the radius of curvature of the interior side 12 does not equal zero (0), which means the first lens 10 and the second lens 20 provide different optical effects. In the present embodiment, refractive indexes of the first and the second lenses 10, 20 are 1.5, and they may have any refractive index accordingly.

The adhesive layer 30 is made of an acrylic composition, which includes an acrylic and an epoxy, and more specifically the acrylic contained in the acrylic composition is more than the epoxy contained therein. Epoxy is photocurable; therefore the adhesive layer 30 is adhesive, and may be employed to solidify large amounts of the acrylic composition to manufacture a plurality of the adhesive layers 30 at a time. The adhesive layer 30 is put in the space S to adhere its opposite sides to the interior side 11, 21 of the first and the second lenses 10, 20. A strength of adhesion of the adhesive layer 30 is preferred greater than 1 kgf/m², and it is greater than 500 kgf/mm² in the present embodiment to provide a better adhesion.

A surprising result of adding an epoxy is the combination of adhesive strength with transparency properties of the material composition of adhesive layer 30 comprising more acrylic than epoxy. In addition, the adhesive layer 30 further has to meet the following characters:
1) Light transmittance greater than 70%;
2) |n3−n1|<0.5; and
3) |n3−n2|<0.5.
where
n1 is a refractive index of the first lens 10;
n2 is a refractive index of the second lens 20; and
n3 is a refractive index of the adhesive layer 30.

In the present embodiment, the light transmittance of the adhesive layer 30 is greater than 95%, and its refractive index is in a range between 1 and 2, and more preferable range is between 1.2 and 1.8. In addition, if the refractive index of the adhesive layer 30 is greater than that of the first lens 10 and that of the second lens 20 but no greater by 0.5 (n3−n1<0.5 and n3|n2<0.5), refraction angles of light between different mediums can be effectively minimized. In practice, the refractive index n3 of the adhesive layer 30 changes based on the refractive indexes n1, n2 of the first and the second lenses 10, 20.

Because of the wavelength of light, a thickness of the adhesive layer 30 is greater than 1 micrometer (μm) to change the optical characters when light emits through the adhesive layer 30.

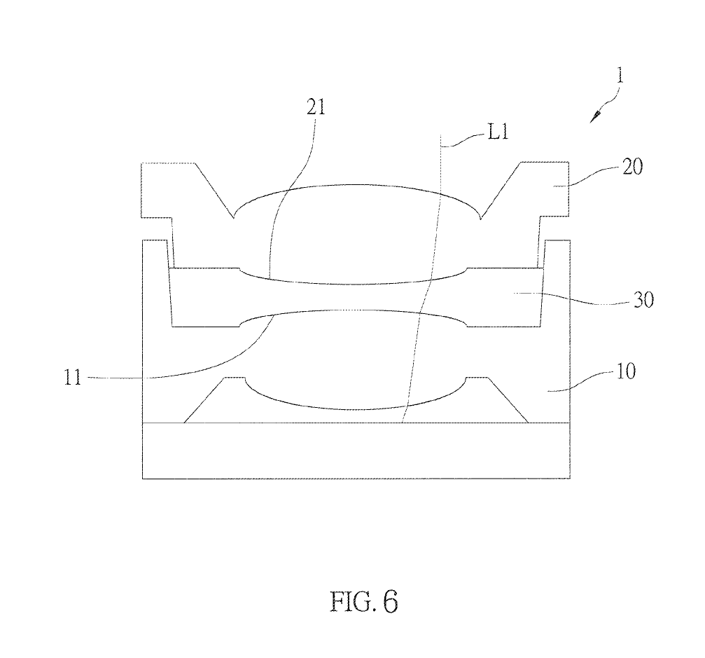

As shown in FIG. 6, the optical lens assembly of the present invention will have a small light shift and high transmittance when light L1 emits therethrough. Besides, the optical character of the optical lens assembly of the present invention will change because of the adhesive layer 30 which means it may reduce the amount of lenses by using the particular adhesive layer 30. As a result, the optical lens assembly of the present invention may have a small size to be squeezed into the image pick-up apparatus of miniaturized modern electronic consumer devices.

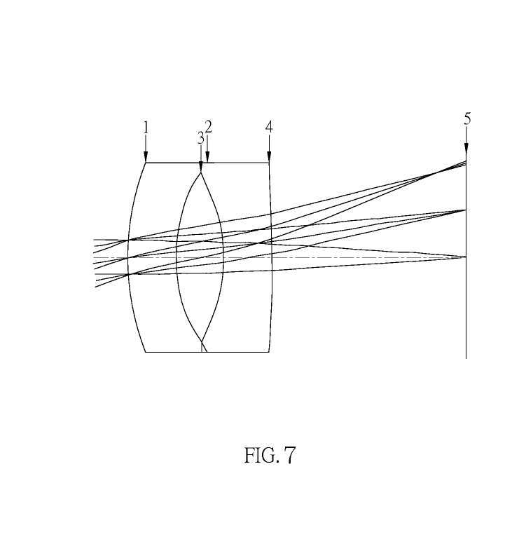

Referring to FIG. 7, the graphic representation of the lens of the preferred embodiment illustrates the reduced imaging distance between surfaces 4 and 5 depicted in thereon, as recorded in the corresponding values in the chart below:

| | Radius of | Distance | Refractive | |
|---|---|---|---|---|
| | curvature | in between | index | Abbe |
| Surface 1 | 0.51416 | 0.095 | 1.530 | 35 |
| Surface 2 | 0.320041 | 0.095 | 1.645 | 20 |
| Surface 3 | −0.32004 | 0.095 | 1.530 | 35 |
| Surface 4 | −3.37378 | 0.385 | Air | |
| Surface 5 | infinite | | | |

The reduced focal length thereby provided affords a compact, small size lens assembly configuration adaptable to increasingly miniaturized contemporary image pick-up devices.

Please note that while manufacturing the optical lens assembly 1 of the present invention, the lens array which includes the first lenses 10, the adhesive layer 30, and another lens array which includes the second lenses 20 can be sequentially aligned together as a stack in advance. The stack is then exposed to light to solidify the adhesive layer 30. As a result, the two lens arrays are adhered to the adhesive layer 30. After that, the optical lens assembly 1 of the present invention can be obtained by simply cutting the stack. The description above is a few preferred embodiments of the present invention and the equivalence of the present invention is still in the scope of claim construction of the present invention.

What is claimed is:

1. An optical lens assembly, comprising a first lens, an adhesive layer, and a second lens in sequence, wherein the first and the second lenses are rectangular in shape;
the adhesive layer is made of an adhesive acrylic composition to adhere both sides thereof to interior sides of the first lens and the second lens, and the adhesive layer has following characters: a transmittance greater than 70%; |n3−n1|<0.5; and |n3−n2|<0.5; where n1 is a refractive index of the first lens; n2 is a refractive index of the second lens; and n3 is a refractive index of the adhesive layer.

2. The optical lens assembly as defined in claim 1, wherein a space is formed between the first lens and the second lens, and the adhesive layer is received in the space.

3. The optical lens assembly as defined in claim 1, wherein a thickness of the adhesive layer is greater than 1 micrometer.

4. The optical lens assembly as defined in claim 1, wherein the refractive index of the adhesive layer is in a range between 1 and 2.

5. The optical lens assembly as defined in claim 1, wherein the refractive index of the adhesive layer is in a range between 1.2 and 1.8.

6. The optical lens assembly as defined in claim 1, wherein the adhesive layer has a strength of adhesion greater than 1 kgf/m².

7. The optical lens assembly as defined in claim 1, wherein the adhesive layer has a strength of adhesion greater than 500 kgf/m².

8. The optical lens assembly as defined in claim 1, wherein a sum of radiuses of curvature of the interior sides of the first lens and the second lens is not equal to zero.

9. The optical lens assembly as defined in claim 1, wherein the transmittance of the adhesive layer is greater than 95%.

10. The optical lens assembly as defined in claim 1, wherein the acrylic composition includes an acrylic and an epoxy, and the acrylic contained in the acrylic composition is more than the epoxy contained therein.

11. The optical lens assembly as defined in claim 1, wherein the adhesive layer further has following character:
n3−n1<0.5.

12. The optical lens assembly as defined in claim 1, wherein the adhesive layer further has following character:
n3−n2<0.5.

13. The optical lens assembly as defined in claim 1, wherein the first lens is cut from a lens array, which includes a plurality of the first lenses integrally arranged in an array.

14. The optical lens assembly as defined in claim 1, wherein the second lens is cut from a lens array, which includes a plurality of the second lenses integrally arranged in an array.
